(19) United States
(12) Patent Application Publication
(10) Pub. No.: US 2019/0145167 A1
(43) Pub. Date: May 16, 2019

(54) Magnetic Child Safety System for the Mechanism of a Chain-Operated Blind

(71) Applicant: Industrias Murtra, S.A., Barcelona (ES)

(72) Inventor: Evaristo Murtra De Anta, Barcelona (ES)

(21) Appl. No.: 16/096,105

(22) PCT Filed: Mar. 15, 2017
(86) PCT No.: PCT/ES2017/070142

§ 371 Date: Oct. 24, 2018

(30) Foreign Application Priority Data
Apr. 28, 2016 (ES) P201630543

(51) Int. Cl. E06B 9/80; E06B 9/78; E06B 9/322

(52) U.S. Cl. CPC E06B 9/80; E06B 2009/785; E06B 9/322; E06B 9/78

(57) ABSTRACT

A magnetic child safety system for a mechanism of a chain-operated blind includes a safety device that can be coupled, via magnetic coupling means, preferably neodymium magnets, to a chain command device, wherein the magnetic coupling means are configured to decouple the safety device from the chain command device when a tension is applied to the chain loop in a vertical direction towards the ground, which is greater than or equal to a predetermined threshold fixed at 6 kg.

### OBJECT OF THE INVENTION

The object of the present invention relates to a magnetic child safety system for the mechanism of a chain-operated blind/curtain comprising a safety device that can be coupled to a chain command device of the type that is placed in a rail. Said magnetic child safety system being configured so that when the chain loop of the safety device is pulled with a force greater than or equal to 6 kg for a maximum of 5 seconds, the safety device automatically decouples from the chain command device, releasing the chain loop, thereby eliminating the danger of the chain loop staying tense and being able to strangle a small child (complying with European law EN 13120).

Once the safety device is decoupled, it can be easily, quickly and automatically coupled back to the chain command device thanks to the attractive force of the magnets that both devices comprise on the inside thereof. The safety device only needs to be brought closer to the chain command device in an intuitive manner.

This has a special application in the scope of the blind and curtain industry.

### TECHNICAL PROBLEM TO BE SOLVED AND BACKGROUND OF THE INVENTION

The strings and chains that are used to actuate blinds/curtains can be dangerous for small children, since they can be accidentally strangled. For this reason, safety devices to prevent this type of accident are on the market.

Current child safety devices are accessories external to the rail of the standard chain-operated blind mechanism and are usually placed at any height of the chain by joining two or more balls of the chain such that when pulled and by exceeding a certain weight, the device opens, releasing the chain.

However, these current child safety devices possess the same disadvantages;
they do not enable the use of continuous chains, which are indispensable for command ratios different than 1:1,
they do not enable a tractive force greater than 3 kg to be exerted in the chain, impeding the actuation of a blind/curtain that weighs more than this,
they cause high friction in the transmission system, reducing the efficiency of the system and they lose effectiveness when they have already been released several times,
devices that are larger than the balls of the very chain cannot pass through the chain command such that the maximum length to be actuated of a blind is equal to the total length of the attached chain, while devices that are equal to or smaller than the balls of the very chain are reset with increased difficulty once they have been opened due to the small size thereof.

Therefore, the present invention solves the problems of the previously mentioned state of the art.

### DESCRIPTION OF THE INVENTION

The present invention relates to a magnetic child safety system for the mechanism of a chain-operated blind comprising a safety device that can be coupled to a chain command device, wherein the safety device comprises a casing and a lid for the casing which house a transmission wheel and a chain loop, wherein the transmission wheel comprises an interior toothing and magnetic coupling means configured to couple the safety device to the chain command device; and the chain command device comprises a fairing and a cover for the fairing that comprise a transmission gear, a base, a set of planetary gears, an actuator of the brake, a transmission of the brake, springs of the brake and a brake cylinder, wherein the transmission gear comprises a toothed head configured to fit into the interior toothing of the transmission wheel of the safety device and magnetic coupling means complementary to the magnetic coupling means of the transmission wheel, wherein the magnetic coupling means are configured to decouple the safety device from the chain command device when a tension is applied to the chain loop in a vertical direction towards the ground, which is greater than or equal to a predetermined threshold fixed at 6Kg.

The magnetic coupling means are preferably a magnet comprised in the transmission wheel and a magnet comprised in the toothed head, and are made of neodymium.

The fairing of the chain command device comprises a protuberance with a frusto-pyramidal shape configured to fit into a recess comprised in the lid of the casing of the safety device.

The safety device has a minimum diameter of 31.7 mm in order to comply with the child safety law in force in Europe.

The casing of the safety device comprises an opening in the lower portion from which the chain loop hangs.

The present invention also refers to a rail for blinds such that it comprises the child safety system described previously.

### DESCRIPTION OF THE FIGURES

To complete the description and for the purpose of facilitating a better understanding of the features of the invention, this specification is accompanied by a set of drawings, as an integral part thereof, where by way of non-limiting example, the following has been represented:

FIGS. 1, 1a, 2 and 2a.—Show different views of the safety system object of the invention, wherein the safety system can be seen coupled to and decoupled from the chain command device.

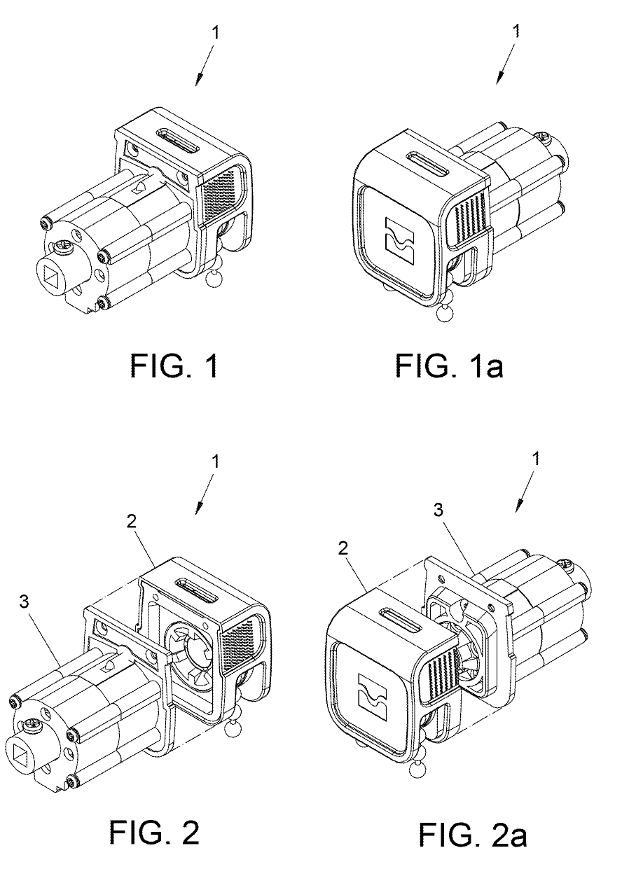

FIGS. 3 and 3a.—Show exploded rear and front views of both the safety device and the chain command device.

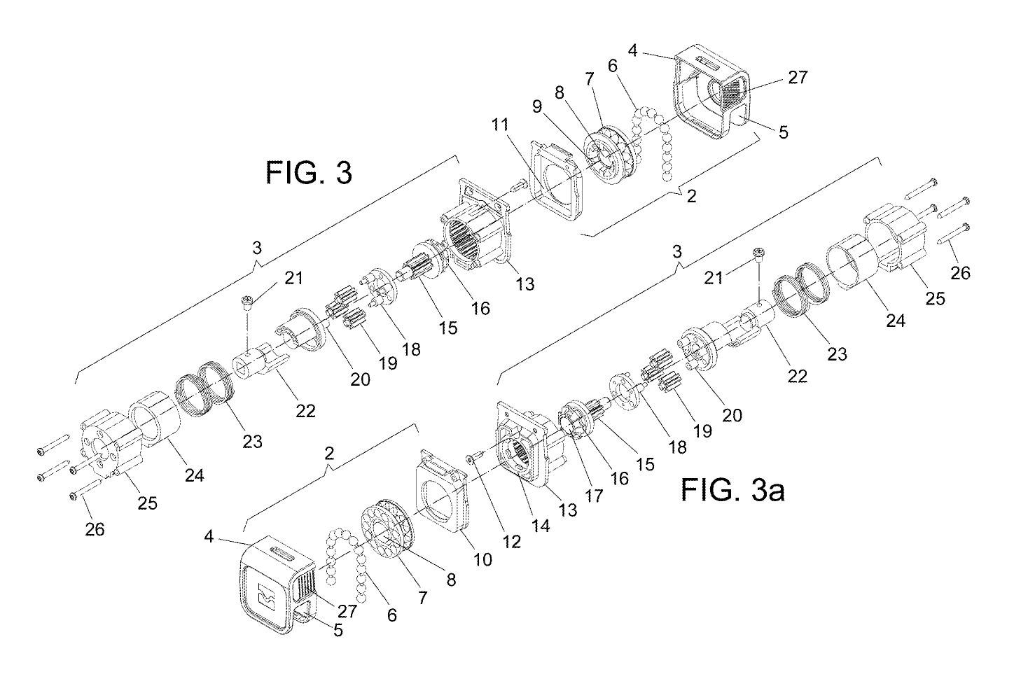

FIGS. 4a, 4b and 4c.—Show a sequence of cross sections that illustrate step by step the process of decoupling from the safety device with respect to the chain command device.

Below is a list of the different elements shown in the figures that are included in the invention:

1. Magnetic child safety system.
2. Safety device.
3. Chain command device.

### 4. Casing.

5. Opening of the casing.
6. Chain loop.
7. Transmission wheel.
8. Magnet of the transmission wheel.
9. Interior toothing.
10. Lid of the casing.
11. Recess of the lid of the casing.
12. Fastening screw of the chain command device.
13. Fairing of the chain command device.
14. Protuberance of the fairing of the chain command device.
15. Transmission gear.
16. Toothed head.
17. Magnet of the transmission gear.
18. Base of the planetary gears.
19. Set of planetary gears.
20. Actuator of the brake.
21. Fastening screw of the shaft.
22. Transmission of the brake.
23. Springs of the brake.
24. Brake cylinder.
25. Cover for the fairing.
26. Closing screws of the chain command device.
27. Rough area.

### DESCRIPTION OF AN EXEMPLARY EMBODIMENT OF THE INVENTION

The object of the present invention relates to a magnetic child safety system (1) comprising a safety device (2) that can be coupled to a chain command device (3) of a standard chain-operated blind mechanism, wherein:
the safety device (2) comprises a casing (4) and a lid for the casing (10) which house a transmission wheel (7) and a chain loop (6) wherein the transmission wheel (7) comprises an interior toothing (9), and
the chain command device (3) comprises a fairing (13) and a cover for the fairing (25) which house a transmission gear (15), a base (18), a set of planetary gears (19), an actuator of the brake (20), a transmission of the brake (22), springs of the brake (23) and a brake cylinder (24), wherein the transmission gear (15) comprises a toothed head (16) that fits into the interior toothing (9) of the transmission wheel (7) of the safety device (2) in order to transmit movement to the transmission gear (15) of the chain command device (3).

Additionally, the safety device (2) and the chain command device (3) comprise complementary magnetic coupling means consisting of a magnet (8) comprised in the transmission wheel (7) and a magnet (17) comprised in the toothed head (16) such that said magnetic coupling means enable the safety device (2) to be coupled and stay fastened to the chain command device (3) due to the magnetic force that they exert on each other when the magnets (8,17) are facing each other. The safety device (2) only needs to be brought closer to the chain command device (3) in an intuitive manner in order for them to be coupled. The casing (4) comprises a rough area (27) which enables a better grip and more comfort.

This magnetic child safety system (1) enables the safety device (2) to be decoupled from the chain command device (3) when a tension is applied to the chain loop (6) in a vertical direction towards the ground, which is greater than or equal to a predetermined threshold fixed at 6Kg.

The transmission wheel (7) is wedged between the casing (4) and the lid of the casing (10), guaranteeing that said transmission wheel (7) cannot come out of the safety device (2) no matter how large the tension exerted on the chain loop (6) is. The casing (4) guides the rotation of the transmission wheel (7).

This transmission wheel (7) rotates due to the tension exerted on the chain loop (6), which gets wedged into the spherical cavities of the upper portion of the transmission wheel (7), and transmits said force to the transmission gear (15) of the chain command device (3). The transmission of the force exerted on the chain loop (6) to the chain command device (3) is guaranteed thanks to the interior toothing (9) of the transmission wheel (7) in which the toothed head (16) of the transmission gear (15) fits thanks to the cohesive force exerted between the magnet (8) of the transmission wheel (7) and the magnet (17) of the transmission gear (15). The magnets (8,17) are made of neodymium in order to guarantee the high durability of the magnetic force.

This cohesive force of the magnets (8,17) can be overcome by the tension exerted on the chain loop (6). In order to control this limit of the forces, the fairing (13) of the chain command device (3) comprises a protuberance (14) in the face oriented towards the safety device (2) with a frusto-pyramidal shape that fits into a recess (11) comprised in the lid of the casing (10) of the safety device (2). The geometry described optimises the retention and durability of the fastening of the safety device (2) and of the chain command device (3), also regulating the necessary tension to be applied to the chain loop (6) in order to overcome the cohesion between the magnets (8,17). This fastening system is extremely robust, compact and reliable.

The design for the fairing (13) and of the lid of the casing (10) facilitate the coupling of the safety device (2) to the chain command device (3) being performed by means of a single position that enhances the transmission of the force and aids easy expulsion if the tension force in the chain loop (6) is exceeded.

The casing (4) of the child safety device (2) comprises an opening (5) in the lower portion from which the chain loop (6) hangs.

Additionally, the magnetic child safety system (1) has the versatility of being coupled either on the right side or on the left side of the rail without needing any changes to be implemented and it can be coupled to and decoupled from the chain command device (3) as many times as desired since it does not lose effectiveness, unlike the conventional safety devices which have notably reduced efficiency after being engaged more than 10 times.

The traction exerted on the chain loop (6) is transmitted to the transmission wheel (7) of the child safety device (2), and this in turn transmits it directly to the transmission gear (15) of the chain command device (3), and this, at the same time, transmits it to the actuator of the brake (20) and is passed on, by opening the springs of the brake (23), directly to the transmission of the brake (22) which is joined to the shaft of the mechanism, which transfers the rotation force to a set of two or more cylinders for falling cords which roll and unroll the falling cords in order to raise (due to the traction transmitted from the chain loop) and lower (due to the effect of gravity) the blinds. The chain command device (3), at the same time it transmits the traction movement exerted on the chain loop (6) to the shaft, frees the pressure of the springs of the brake (23) which holds back the force that gravity exerts when no traction is exerted on the chain loop (6) (state of rest).

The use of chain command devices (3) with a ratio of ¼ or ⅕ enables very heavy blinds or curtains to be actuated with the same safety device (2) when the force that the curtain exerts is divided by multiplying the number of coils exerted on the chain command device (3).

The diameter of the safety device (2) must have a minimum measurement that cannot fit into a diameter of 31.7 mm in order to comply with the child safety law in force in Europe (EN 13120) which determines this measurement as the maximum diameter of the trachea of a child (able to accidentally swallow the safety device) in order to prevent possible suffocation due to obstruction of the respiratory passageway.

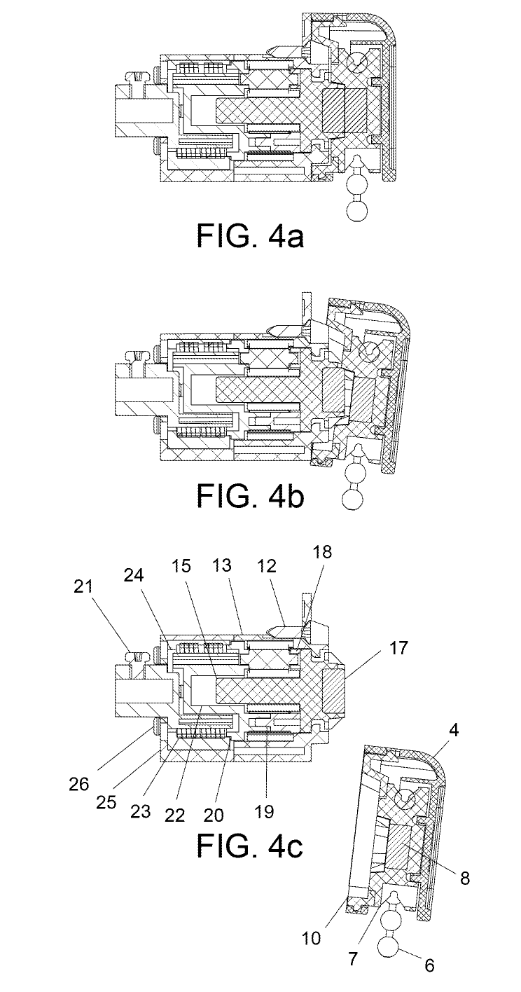

In FIGS. 4a, 4b and 4c the sequence of how the safety device (2) is decoupled from the chain command device (3) after the chain loop (6) has received a tension greater than or equal to 6Kg. When the child safety device (2) has been the decoupled, the weight of the blind pulls on the strings of the falling cord towards the ground and when there is no force received on the chain loop (6), the chain command device (3) is braked by the springs of the brake (23) which rest by expanding to the brake cylinder (24), and only releases said pressure when it receives traction on the chain loop (6) which contracts the springs of the brake (23) due to the force exerted by the actuator of the brake (20).

The child safety device (2) is completely compatible with the chain command devices (3) in a direct ratio of 1:1 (with which when 1 metre of chain is pulled, exactly 1 meter of blind is raised) or a reduced ratio (with which when 1 metre of chain is pulled, approximately 0.25 metres of blind is raised).

The present invention should not be taken to be limited to the embodiment herein described. Other arrangements may be carried out by those skilled in the art based on the present description. Accordingly, the scope of the invention is defined by the following claims.

1. A magnetic child safety system for mechanism of a chain-operated blind comprising a safety device that can be coupled to a chain command device wherein:
the safety device comprises a casing and a lid for the casing which house a transmission wheel and a chain loop, wherein the transmission wheel comprises an interior toothing and magnetic coupling means configured to couple the safety device to the chain command device,
the chain command device comprises a fairing and a cover for the fairing which house a transmission gear, a base, a set of planetary gears, an actuator of the brake, a transmission of the brake, springs of the brake and a brake cylinder, wherein the transmission gear comprises a toothed head configured to fit into the interior toothing of the transmission wheel of the safety device and magnetic coupling means complementary to the magnetic coupling means of the transmission wheel wherein the magnetic coupling means are configured to decouple the safety device from the chain command device when a tension is applied to the chain loop in a vertical direction towards the ground, which is greater than or equal to a predetermined threshold.

2. The magnetic child safety system for the mechanism of the chain-operated blind according to claim 1, wherein the magnetic coupling means are a magnet included in the transmission wheel and a magnet included in the toothed head.

3. The magnetic child safety system for the mechanism of the chain-operated blind according to claim 2, wherein the magnets are made of neodymium.

4. The magnetic child safety system for the mechanism of the chain-operated blind according to claim 1, wherein the fairing of the chain command device comprises a protuberance with a frusto-pyramidal shape configured to fit into a recess defined in the lid of the casing of the safety device.

5. The magnetic child safety system for the mechanism of the chain-operated blind according to claim 1, wherein the safety device has a minimum diameter of 31.7 mm.

6. The magnetic child safety system for the mechanism of the chain-operated blind according to claim 1, wherein the predetermined threshold is fixed at 6Kg.

7. The magnetic child safety system for the mechanism of the chain-operated blind according to claim 1, wherein the casing of the safety device comprises an opening in the lower portion from which the chain loop hangs.

8. A rail for blinds wherein the rail comprises a magnetic child safety system as described in claim 1.
